(19) United States
(12) Patent Application Publication
(10) Pub. No.: US 2011/0155666 A1
(43) Pub. Date: Jun. 30, 2011

(54) METHOD AND SYSTEM USING HYBRID FORWARD OSMOSIS-NANOFILTRATION (H-FONF) EMPLOYING POLYVALENT IONS IN A DRAW SOLUTION FOR TREATING PRODUCED WATER

(75) Inventors: Prakhar Prakash, San Ramon, CA (US); Randall Boyd Pruet, Surrey (GB); De Q. Vu, El Cerrito, CA (US)

(73) Assignee: Chevron U.S.A. Inc.

(21) Appl. No.: 12/650,299

(22) Filed: Dec. 30, 2009

(51) Int. Cl. C02F 1/44; B01D 61/18; C02F 101/30; C02F 101/10; C02F 101/32

(52) U.S. Cl. 210/641; 210/321.64

(57) ABSTRACT

A method and system using hybrid forward osmosis and nanofiltration is disclosed for treating produced water containing contaminant species. The system comprises a forward osmosis cell and a downstream nanofiltration cell. A draw solution fluid cycles between the forward osmosis cell and the nanofiltration cell. The draw solution contains polyvalent osmotic agents producing polyvalent ions in the draw solution. The passage of monovalent ions through the nanofiltration membrane is hindered due to the presence of conjugate polyvalent ions.

### TECHNICAL FIELD

The present disclosure relates generally to processes and apparatus to treat produced water from upstream operations in the oil and gas exploration industry, and more particularly, to those processes and apparatus that utilize membranes for separations.

### BACKGROUND OF THE INVENTION

For every barrel of crude oil produced, three to ten barrels of water are also generated during oil exploration. Water needs to be separated from the produced fluids that include crude oil, gas, various contaminants and water. In the oil and energy industry, this water is referred to as “Produced Water.” Produced water contains large quantities of dissolved and suspended hydrocarbons. It also has a large concentration of inorganics and it often has a high degree of salinity.

Produced water is generated in both on-shore and off-shore operations. Due to environmental concerns and increasing public interest in the need for water, there is wide interest in treating this produced water for beneficial re-use. For example, the produced water may have significant amount of hardness and silica. If these contaminants are removed, produced water can be used to produce steam, which in turn, can be reinjected for steamflooding operations. The produced water may have high concentration of chlorides and boron. If these contaminants are sufficiently removed from produced water, then the water may be reused such as for irrigation purposes.

There are several approaches to treating produced water depending on the end use. But often, these approaches are very elaborate. They may involve several unit operations and are also fairly energy intensive. For example, N.A. Water Systems of Coraopolis, Pa. has announced the successful full-scale demonstration of OPUS™ technology for produced water treatment. OPUS removes contaminants sufficiently for treated produced water to be discharged into shallow groundwater recharge basins, allowing greater oil production and replenishing precious water resources. This technology consists of multiple treatment processes, including degasification, chemical softening, media filtration, ion exchange softening, cartridge filtration and reverse osmosis (RO). Accordingly, use of this technology involves large capital expenditures and high operational costs. There is a need for a technology that uses fewer unit operations and is less energy intensive. The present invention addresses this need for a treatment process that requires less capital and operating expenses.

### SUMMARY

A method and system using hybrid forward osmosis and nanofiltration is disclosed for treating produced water containing contaminant species. The system comprises a forward osmosis cell and a nanofiltration cell. The forward osmosis cell includes a forward osmosis (FO) feed chamber and a forward osmosis (FO) draw chamber separated by a forward osmosis (FO) membrane. The FO draw chamber includes a draw solution containing a solution including polyvalent osmotic agents. The nanofiltration cell includes a nanofiltration (NF) draw chamber and a nanofiltration (NF) permeate chamber separated by a nanofiltration membrane. The NF draw chamber is in fluid communication to receive an outlet draw solution from the FO draw chamber and in fluid communication to deliver an inlet draw solution to the FO draw chamber.

In the method, produced water containing contaminant species may be introduced into the FO feed chamber with the produced water being separated into a contaminant species enriched retentate stream in the FO feed chamber and a first contaminant species depleted permeate stream in the FO draw chamber to mix with the draw solution to form the outlet draw solution. The outlet draw solution is separated by the nanofiltration membrane into a contaminant species enriched inlet draw solution in the NF feed chamber which is recycled to the FO draw chamber and a second contaminant species depleted permeate stream in the NF permeate chamber.

The contaminant species which are of particular interest for removal from produced water includes silica, boron, calcium ions, magnesium ions, dissolved organics, free oil and grease. Preferred polyvalent osmotic agents are selected from one or more of Na₂SO₄, MgCl₂, AlCl₃, MgSO₄. The present invention relies upon an important aspect of ion transport, i.e., a coupled transport process. The presence of polyvalent ions in the draw solution inhibits the passage of monovalent ions through the nanofiltration membrane.

### BRIEF DESCRIPTION OF THE DRAWINGS

FIG. 1 is a schematic drawing of a hybrid forward osmosis-nanofiltration (H-FONF) process for treating produced water.

FIG. 2 is a schematic drawings illustrating solvent flows for forward osmosis, pressure retarded osmosis (PRO), and reverse osmosis;

FIG. 3 is a graph showing water flow rates using forward osmosis;

FIG. 4 is a graph showing dissolved organic content in water during forward osmosis; and

FIG. 5 is a graph showing forward osmosis membrane performance.

### DETAILED DESCRIPTION

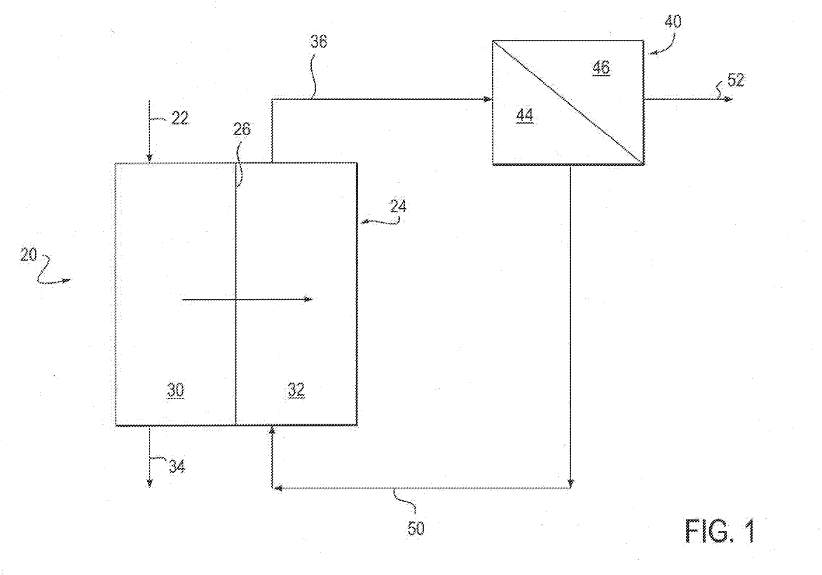

FIG. 1 shows one embodiment of a hybrid forward osmosis-nanofiltration system 20 made in accordance with the present invention. Particular details of system 20 will be offered below after some theoretical discussion is provided regarding the forward osmosis and nanofiltration processes used in the present invention.

### Forward Osmosis:

Osmosis is the molecular diffusion of a solvent across a semi-permeable membrane (which rejects the solute) and is driven by a chemical potential gradient. This gradient is caused by differences in component concentration, pressure and/or temperature across the membrane. In the non-ideal case, the use of solvent activity in lieu of the concentration accounts for the solvent-solute interactions. At a constant temperature, the chemical potential is defined by Eqn (1):

μᵢ=μᵢ°+RT ln aᵢ+VᵢP (1)

where
μ°ᵢ is the chemical potential of 1 mol of pure substance at a pressure P and temperature T,
aᵢ is the activity of component i (1 for pure substances),
R is the gas constant and
Vᵢ is the molar volume of component i.

The driving force is defined as the osmotic pressure of the concentrated solution. The membrane permeable species (solvent) diffuses from the region of higher activity to a region of lower activity. The osmotic pressure is the pressure that must be applied to a concentrated solution to prevent the migration of solvent from a dilute solution across a semi-permeable membrane. A common application of this phenomenon is the desalination of seawater using “reverse osmosis (RO)” using hydraulic pressure to overcome the osmotic pressure, (also, known as hyperfiltration). It is used to reverse the flow of the solvent (water) from a concentrated solution (e.g. seawater) to obtain potable water.

Osmotic pressure can be calculated from the activity (the product of the mole fraction (x) and activity coefficient (γ)) of the solvent in the two solutions. The relationship is as follows in Eqn. (2):

$$Δπ = \frac{RT}{{V}_{i}} ln [ \frac{{x}^{1} {γ}^{1}}{{x}^{2} {γ}^{2}} ] \qquad ( 2 )$$

where R is the gas constant,
T is the temperature,
Vᵢ is the molar volume of the solvent (water),
x¹ and γ¹, x² and γ² refer to the water mole fraction and activity coefficients in the higher activity (1) and lower activity (2) solutions respectively.

In the absence of the hydraulic pressure for reverse osmosis, the solvent flow will continue until the chemical potential equalizes in both the feed and the draw solution. This ‘natural’ flow of solvent is called forward osmosis. Early research on extracting energy from direct/forward osmosis (FO) helped identify several potential applications. Power generation using natural concentrated salt reservoirs (e.g. Dead Sea, Great Salt Lake) was proposed in the mid 1970s using membranes employing a so-called pressure retarded osmosis (PRO) process. Loeb, S., Production of energy from concentrated brines by pressure-retarded osmosis: I. Preliminary technical and economic correlations. Journal of Membrane Science, 1976. 1: p. 49-63. In the process, mechanical energy is extracted by applying a pressure lower than the osmotic pressure.

Another potential application of forward osmosis is the direct production of electricity using electrodialysis. Wick, G. L., Power from salinity gradients, Energy, 1978 3(1): p. 95-100. Utilizing the vapor pressure difference between the two solutions for power generation has also been suggested. Olsson, M. S., Salinity-gradient vapor-pressure power conversion, Energy, 1982. 7(3): p. 237-246.

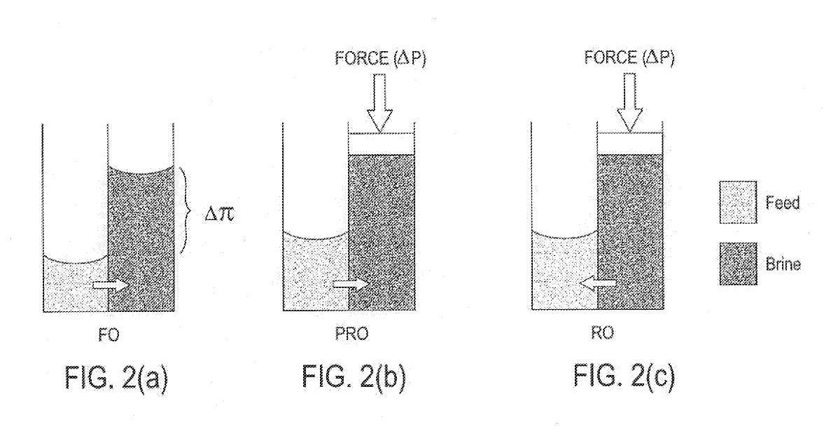

FIG. 2 depicts the difference among FO, PRO and RO for a feed (dilute solution) and brine (concentrated solution). For FO, ΔP is zero; for RO, ΔP>Δπ (osmotic pressure); and for PRO, Δπ>ΔP. A general flux relationship for FO, PRO and RO for water flux from higher activity to lower activity (i.e. FO) is as follows in Eqn. (3):

J_{w}=A(σΔπ−ΔP) (3)

where A is the water permeability constant of the membrane,
σ the reflection coefficient, and
ΔP is the applied pressure difference.
For forward osmosis, the applied pressure difference ΔP is zero.

The reflection coefficient accounts for the imperfect nature (solute rejection less than 100%) of the membrane. The reflection coefficient is 1 for complete solute rejection.

High osmotic pressures can be generated with aqueous salt solutions. The high osmotic pressure can be used to draw water from a dilute solution to a concentrated solution. The following Table 1 shows osmotic pressure values for various salt solutions at saturation concentrations:

TABLE 1
Osmotic Pressure for various draw solutions

| | Saturation Concentration | Osmotic pressure |
|---|---|---|
| Osmotic agent | (wt %) | (atm) |
| Sodium chloride | 26.4 | 360 |
| Magnesium chloride | 32.2 | 1090 |
| Aluminum chloride | 30.5 | 950 |
| Sodium sulfate | 31.9 | 40 |
| Ammonium nitrate | 44.4 | 690 |
| Sodium acetate | 60.9 | 180 |
| Potassium acetate | 66.2 | 240 |

Thus, by choosing an appropriate salt in the draw solution, it is possible to pull water from a feed solution of produced water. McCutcheon, J. R., McGinnis, R. L., and Elimelech, M, Desalination by ammonia-carbon dioxide forward osmosis: Influence of draw and feed solution concentrations on process performance, Journal of Membrane Science 278 (2006) 114-123.

The process has several potential benefits such as:
a) the process may reject a wide range of contaminants;
b) membrane fouling tendencies may be much lower than pressure driven membrane processes such as NF and RO;
c) the process may need less membrane support and equipment because such processes are very simple;
d) the process may be a less energy intensive process; and
e) the process may eliminate the need for several unit operations.

Experiments were carried out with a sample of produced water as feed and a 2.5M concentrated solution of sodium chloride. Another experiment was conducted with a 2.5 M concentrated solution of magnesium chloride. One liter of each solution was fed to feed and draw cells and was separated by a cellulose-based polymeric forward osmosis membrane with an effective area of exchange of 36 cm². The following observations were made:

### Draw Solution Performance:

Both sodium chloride and magnesium chloride were found to be good choices for forward osmosis experiments. The average flux for a four hour experiment ranged 8-9 L/m²-hr for sodium chloride and nearly 12-13 L/m²-hr for magnesium chloride. Both the electrolytes can be considered as good candidates for the FO process, but magnesium chloride performed better because of its higher initial osmotic pressure.

### Membrane Fouling:

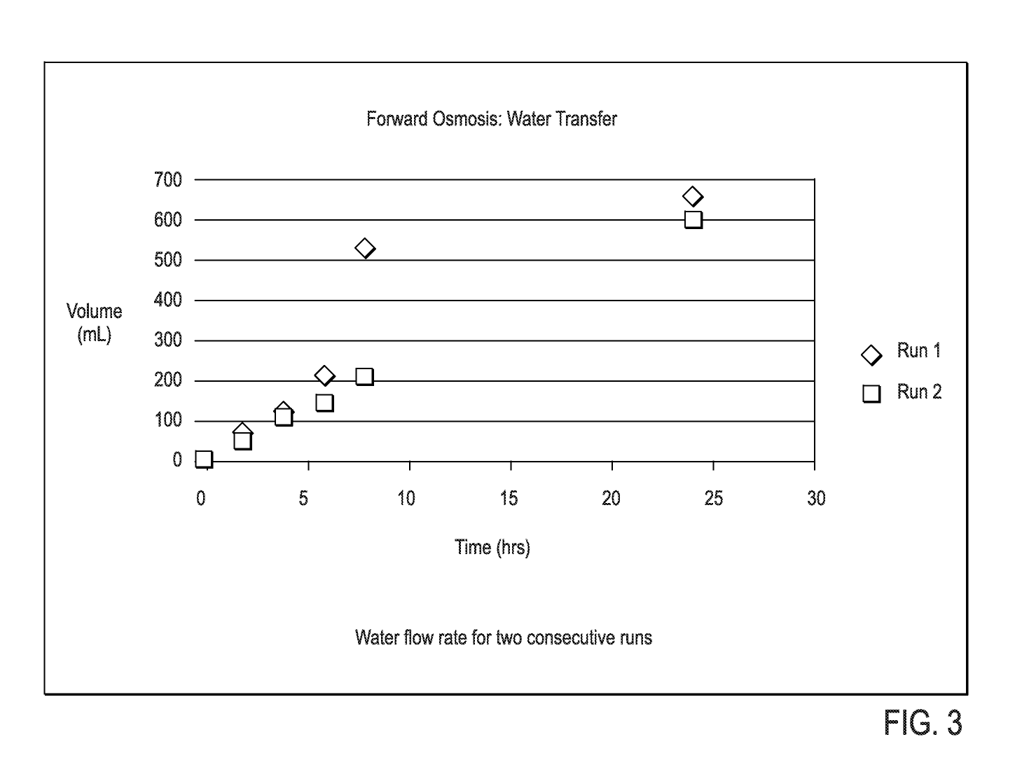

During a 24 hour period of experiment, approximately 55% of feed water was transferred from the feed water cell to the draw solution cell using sodium chloride in the draw solution. The transfer is shown in the plot in FIG. 3.

The average flux for a 4 hour experimental run was determined to be 9.1 L/m²-hr for the first run and 8.1 L/m²-hr for the second run. Considering that significant membrane fouling occurs in the first few hours of the run in a pressure driven process, forward osmosis process did not show any appreciable fouling.

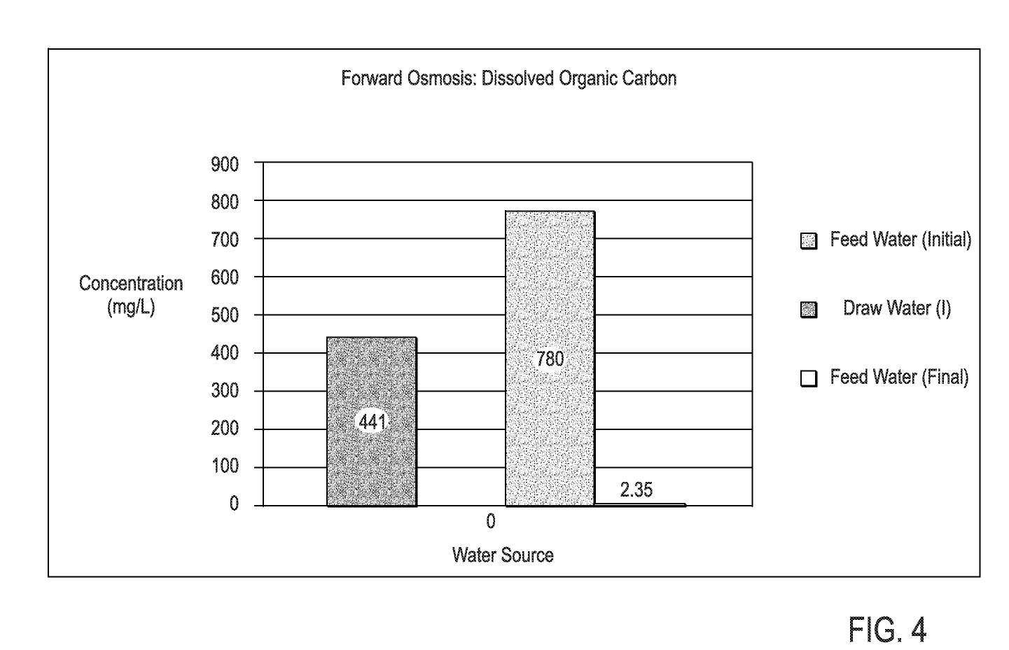

The dissolved organic carbon in water is another measure of the fouling propensity of membranes. FIG. 4 indicates that the outlet draw solution is very low in organic content. Therefore if this draw water is subjected to another membrane process with sufficiently high feed pressure, it will have considerably lower fouling. Visually too, the quality of product water in the draw side of the forward osmosis cell was much better than in the feed cell.

### Quality of Product Water for Beneficial Reuse:

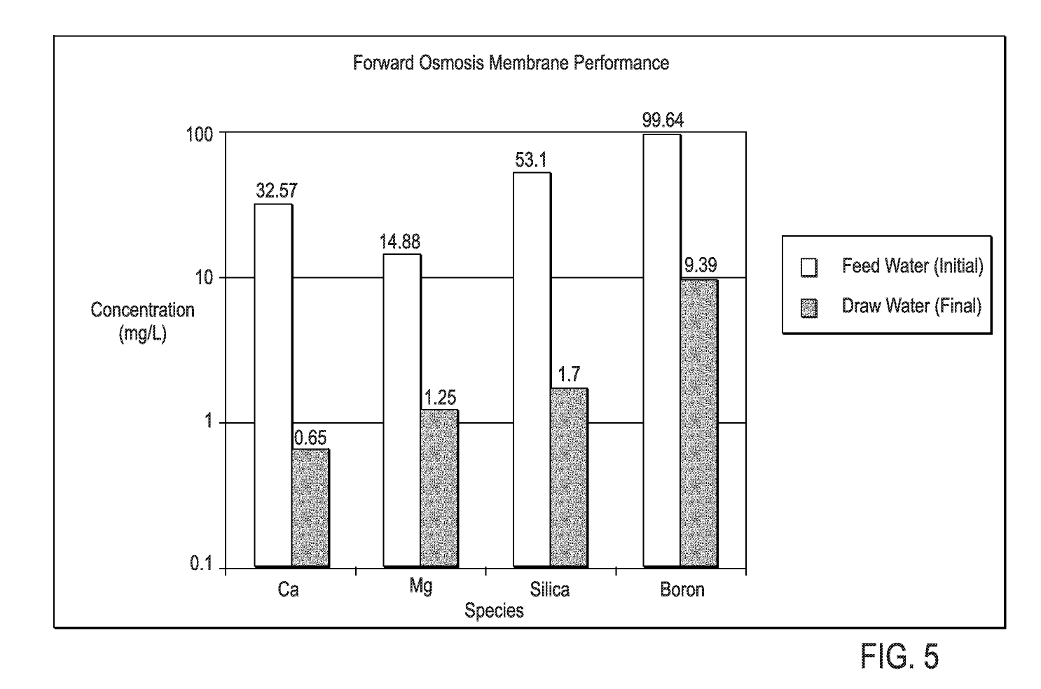

From an application standpoint, a couple of promising beneficial reuses of water can be either for steam generation or for irrigation purposes. For the former, scaling of boilers/steam generators is a significant challenge. Therefore, the concentration of scalants such as metal hardness (magnesium and calcium) and silica should be very low. For irrigation purposes, the concentration of boron should be lower than 0.5 ppm. With these considerations, forward osmosis provides a partial solution to address these concerns. In the process, forward osmosis is able to eliminate several unit operations such as chemical softening, media filtration, ion exchange softening, cartridge filtration, and dissolved organic carbon removal units. The benefits can be seen in FIG. 5.

While the concentration of boron is still above 0.5 mg/L, a more than 90% reduction means that the unit operation downstream of the process such as reverse osmosis or ion-exchange will be more efficient and would require less energy and treatment chemicals.

The draw solution is a concentrated electrolyte. The water permeate from forward osmosis needs to be recovered from the electrolyte, in order to reuse it. Surprisingly, a nanofiltration process can be beneficially used for this purpose when using a polyvalent osmotic agent. Such an agent will provide polyvalent ions to a solution when dissolved in water. The polyvalent ions in a feed solution, which is the draw solution from the upstream forward osmosis process, retard the flow of monovalent ions through the nanofilration membrane. Accordingly, many contaminate species including such monovalent ions can be effectively reduced using the present hybrid forward osmosis and nanofiltration system.

### Nanofiltration:

For the purposes of the present application, the term “nanofiltration” refers to a form of filtration that uses semipermeable membranes of pore size 0.001-0.1 μm to separate different fluids or ions, removing materials having molecular weights in the order of 300-1000 dalton. Nanofiltration is most commonly used to separate solutions that have a mixture of desirable and undesirable components. An example of this is the removal of calcium and magnesium ions during water softening. Nanofiltration is capable of removing ions that contribute significantly to osmotic pressure, and this allows separation at pressures that are lower than those needed for reverse osmosis. While reverse osmosis may operate at about 800-1000 psi, nanofiltration more typically operates at a pressure of approximately 150 psi.

Conventionally, concentrated electrolytes such as brine can be desalinated using reverse osmosis membranes. Several researchers have combined reverse osmosis processes with forward osmosis to recover the FO permeate as RO permeate using sodium chloride as an electrolyte. It is recognized that RO membranes are extremely compact and they typically operate at 700-900 psi range. Therefore they are energy intensive. In comparison, nanofiltration requires relatively less feed pressure and their application can therefore save significantly on energy costs. However, the salt rejection for sodium chloride using nanofiltration membranes is very low compared to over 99.5% salt rejection using RO membranes. NF membranes cannot be successfully used as a barrier when the draw solution is sodium chloride or a salt composed of monovalent ions.

Polyvalent ions (sulfates, magnesium) are largely rejected by the nanofiltration membranes. An important aspect of ion transport is that it is a coupled transport process. Thus, if the salt under consideration has an ion such as sulfate (from sodium sulfate) or magnesium (from magnesium chloride), the passage of monovalent ions is also hindered due to the presence of conjugate polyvalent ions because of the coupled transport phenomenon which preserves the electroneutrality of the salt solution. J. Schaep, B. Van der Bruggen, C. Vandecasteele, D. Wilms, Influence of Ion size and charge in nanofiltration, Sep. Purif. Technol. 14 (1998) 155-162. A. W. Mohammad, N. Hilal, H. Al-Zoubi, N. A. Darwish, Prediction of permeate fluxes and rejections of highly concentrated salts in nanofiltration membranes, J. Membr. Sci. 289 (2007) 40-50. N. Hilal, H. Al-Zoubi, N. A. Darwish, A. W. Mohammad, Performance of nanofiltration membranes in the treatment of synthetic and real seawater, Sep. Sci. Technol. 42 (3) (2007) 493-515.

In the present invention, sodium chloride can be substituted with polyvalent salts in the draw solution and reverse osmosis membranes are replaced with nanofiltration membranes.

The hybrid process H-FONF can have significant energy savings. Software entitled ROSA (Reverse Osmosis System Analysis), available from Dow Water & Process Solutions of Midland, Mich., United States, was used to quantitatively illustrate this point. The findings are summarized in Table 2 below:

TABLE 2
Performance comparison of nanofiltration system (using
polyvalent conjugate ion) with monovalent reverse osmosis
system (using monovalent conjugate ion)

| Membrane System | NF | RO |
|---|---|---|
| Electrolyte | Na₂SO₄ | NaCl |
| Electrolyte Concentration | 310 | 310 |
| (meq/L) | | |
| Feed Rate (gpm) | 25 | 25 |
| Permeate Rate (gpm) | 12.5 | 12.5 |
| Sodium Rejection (%) | 96 | 99.5 |
| Feed Side Pressure (psig) | 305 | 792 |
| Pressure ratio (RO/NF) | | 2.60 |
| Energy Cost (kWh/kgal) | 5.61 | 14.45 |
| Energy Cost ratio (RO/NF) | | 2.58 |

Table 2 illustrates that though the salt rejection for NF system is not as high as for RO system, the pressure requirements are significantly lower and so is the energy consumption per kgal of produced water. A subsequent polishing step (RO or ion-exchange) will be energetically less costly.

In summary, the H-FONF process is a unique process for produced water treatment and has the following benefits:

(a) reduces the volume of untreated produced water volume for reinjection;
(b) recovers water low in silica, hardness, boron, and dissolved organic carbon—producing good quality water for beneficial reuse;
(c) recovers for low energy costs, thereby reducing operating cost;
(d) recovers with minimization of many unit operations employed in other processes; and
(e) recovers with recycle of electrolyte.

Example of a Hybrid Forward Osmosis/Nanofiltration System Using Polyvalent Conjugate Ions

### DETAILED DESCRIPTION OF THE PREFERRED EMBODIMENT

FIG. 1 shows one embodiment of a hybrid forward osmosis (FO) and nanofiltration (NF) system (H-FONF) 20 for treating produced water containing contaminant species. H-FONF system 20 employs a draw solution containing polyvalent osmotic agents. Two processes are disclosed that work in tandem to treat produced water. The first is forward osmosis and the second process is nanofiltration.

The processes work in conjunction as a hybrid process. The forward osmosis process was experimentally conducted to provide the permeate flow rate through the forward osmosis membrane. The particular membrane used was a cellulose triacetate membrane embedded about a polyester screen mesh and was obtained from Hydration Technologies Inc., Albany, Oreg. This experimentally determined permeate flow rate was then used as an input into the ROSA software. The ROSA software provided the operating conditions for the nanofiltration cell such as the pressure requirements, power consumption/gallon of water treated, and the area of the nanofiltration membrane required to achieve the permeate flow rate from the forward osmosis cell—in accordance with the principle of mass balance.

A stream 22 of produced water is provided to a forward osmosis cell 24 at an estimated flow rate of 500 gpm (gallons per minute) in this exemplary embodiment. The experimentally determined permeate flow rate through the forward osmosis membrane is used to extrapolate to estimate the necessary membrane area to achieve the 500 gpm flow rate. The osmotic pressure of the stream 22 of produced water introduced into the FO cell 24 is 13.6 atmospheres based on the composition provided in Table 3. This estimate of the osmotic pressure is determined using a software entitled OLI Stream Analyzer 2.0 (OLI Systems, Morris Plains, N.J.).

The produced water is assumed to have numerous contaminant components which shall be referred to herein as “contaminant species”. Those skilled in the art of treating produced water will appreciate that produced water may contain many other components, depending on the characteristics of the particular subterranean formation from which produced fluids are captured. Common components which are highly desirable to remove for a successful H-FONF process include silica (scaling issues); calcium and magnesium ions (scaling and hardness); boron and salinity (irrigation). For this particular exemplary embodiment, Table 3 shows the composition of the stream 22 of produced water that was used in the experiment:

TABLE 3
Composition of Feed Stream 22

| Component of Feed Stream | Concentration, mg/L |
|---|---|
| Bicarbonates | 1100 |
| Chlorides | 3025 |
| Calcium | 40 |
| Magnesium | 20 |
| Sodium | 1660 |
| Silica | 220 |
| Boron | 100 |

Osmotic cell 24 includes a forward osmosis membrane 26 which divides FO cell 24 into a retentate or FO feed chamber 30 and a permeate or FO draw chamber 32. An osmotic draw solution in FO draw chamber 32 contains polyvalent osmotic agents that disassociate to provide strong polyvalent electrolytes or ions that are used to draw water from the FO feed chamber 30. The area of forward osmosis membrane 26 is sized to permit a permeate draw rate of about 450 gallons per minute, for example.

Water which is not drawn through forward osmosis membrane 26 is removed from FO feed chamber 32 as a reject stream 34 of produced water enriched in the concentration of rejection components (silica, Ca, Mg, DOC, boron) as compared to the produced water stream 22. That is, reject stream 34 is a contaminant species enriched retentate stream. Reject stream 34 exits from the FO feed chamber 32 at a rate 50 gallons per minute and at an osmotic pressure of 136 atmospheres. Reject stream 34 can be disposed of such as by pumping reject stream 34 into a disposal subterranean formation.

### Polyvalent Osmotic Agents

In this particular exemplary embodiment, the osmotic draw solution is made from magnesium chloride, MgCl₂, which is initially at a molarity concentration of 1.25M. By way of example and not limitation, Table 4 shows a list of various polyvalent osmotic agents which may be used in H-FONF system 20.

TABLE 4
Polyvalent Osmotic Agents

| | Saturation Concentration | Osmotic Pressure |
|---|---|---|
| Osmotic Agent | (wt %) | (Atm) |
| Na₂SO₄ | 31.9 | 40 |
| MgCl₂ | 32.2 | 1090 |
| AlCl₃ | 30.5 | 950 |
| MgSO₄ | | Not known |
| (Al)₂(SO₄)₃ | | Not known |

U.S. Pat. No. 6,849,184 describes a forward osmosis membrane that can be with the present embodiment. Such membranes are commercially available from Hydration Technologies, Inc. of Albany, Oreg., USA. The FO elements are preferably made from a casted membrane made from a hydrophilic membrane material, for example, cellulose acetate, cellulose proprianate, cellulose butyrate, cellulose diacetate, blends of cellulosic materials, polyurethane, polyamides. Preferably the membranes are asymmetric, that is the membrane has a thin rejection layer on the order of 10 microns thick and a porous sublayer up to 300 microns thick. For mechanical strength they are in one embodiment cast upon a hydrophobic porous sheet backing, wherein the porous sheet is either woven or non-woven but having at least about 30% open area. Preferably, the woven backing sheet is a polyester screen having a total thickness of about 65 microns (polyester screen) and total asymmetric membrane is 165 microns in thickness. Preferably, the asymmetric membrane was caste by an immersion precipitation process by casting the cellulose material onto the polyester screen. In a preferred embodiment, the polyester screen was 65 microns thick, 55% open area.

### Nanofiltration Cell

An outlet draw stream 36 is taken from FO draw chamber 32 and is delivered to a nanofiltration cell 40. Outlet draw stream 36 is a mixture of the draw solution already in draw chamber 32 and the permeate stream which permeates through the FO membrane 26, i.e., the contaminant species depleted permeate stream. Outlet draw stream 36 has an osmotic pressure of 30 atmospheres.

Nanofiltration cell 40 includes a nanofiltration filter 42 that separates a NF feed chamber 44 from a NF permeate chamber 46. On the retentate side, an inlet draw solution 50 is transferred from NF feed chamber 44 to FO draw chamber 32 at a flow rate of 100 gpm. The inlet draw solution has an osmotic pressure of 150 atm. This is the equivalent of MgCL2 concentration of 0.5M.

This inlet draw solution 50 is enriched in monovalent contaminate species as compared to the outlet draw solution 36 which is introduced into nanofiltration cell 40. A NF permeate stream 52 is withdrawn from the NF permeate chamber 46. The NF permeate stream 52 may also be referred to as a second monovalent species depleted permeate stream. As a result of the presence of the polyvalent ions in the NF cell, monovalent ions which otherwise would permeate through the NF membrane are retained in the draw solution because of the conjugation of the polyvalent ions. Overtime, the retention of the contaminants in the draw solution will accumulate increasing the concentration in the draw solution. Therefore, the draw solution will have to be occasionally ‘blown down’. Blown down refers to removing a portion of the draw solution containing the concentrated contaminants and replacing that portion with a fresh draw solution containing a polyvalent osmotic agent.

Various nanofiltration membranes are available commercially. Dow Water & Process Solutions of Midland, Mich., USA, offers several nanofiltration membranes such as Filmtec NF90, Filmtec NF200, and Filmtec NF 270 membranes. In particular, NF 270 membranes have a high salt rejection of over 97% and a high calcium ion rejection.

H-FONF system 20 significantly removes the amount of contaminants in produced water 22. For example, in this exemplary embodiment initially 100 ppm of boron were in stream 22 of produced water. Stream 36 of outlet draw solution introduced into nanofiltration cell 40 contains only about 10 ppm of boron. Finally, stream 52 of NF permeate water contains only 2-3 ppm of boron. The H-FONF system 20 can be used to remove additional monovalent contaminant species as well. One or more of numerous polyvalent osmotic agents can also be used to create the osmotic draw solution. Accordingly, a very energy efficient system may be used which will reduce the cost of removing the contaminant species, i.e., from 100 ppm boron to 2-3 ppm.

If further treatment is required to lower the concentration of the monovalent contaminant species in stream 52, such as boron, other additional processes may be used to treat stream 52 such as reverse osmosis or ion-exchange. Because H-FONF system 20, employing a polyvalent osmotic draw solution, has greatly reduced the concentration of the contaminant species, the cost of using these further treatment processes to lower the concentration of the contaminant species will be greatly reduced.

While in the foregoing specification this invention has been described in relation to certain preferred embodiments thereof, and many details have been set forth for purpose of illustration, it will be apparent to those skilled in the art that the invention is susceptible to alteration and that certain other details described herein can vary considerably without departing from the basic principles of the invention. While the produced water above has been described as being produced from a subterranean reservoir or formation, the produced water may come from other sources. By way of example and not limitation, the produced water maybe the product made a Fischer-Tropsch conversion of synthesis gas to Fischer-Tropsch products. As those skilled in the art of water filtration will appreciate, the present H-FONF method and system can also be used to treat produced water from other sources.

What is claimed is:

1. A process for treating produced water containing contaminant species, the process comprising:
separating produced water containing contaminant species using forward osmosis (FO) and a draw solution containing polyvalent osmotic agents to produce a FO retentate stream enriched in the contaminant species and a FO permeate stream depleted in the contaminant species and mixed with the draw solution containing the polyvalent osmotic agents; and
separating the FO permeate stream mixed with the draw solution containing the contaminant species and the polyvalent osmotic agents using nanofiltration (NF) to produce a NF retentate stream enriched in the contaminant species and a NF permeate stream depleted in the contaminant species.

2. The process of claim 1 wherein:
the contaminant species is selected from one or more of the group consisting of silica, boron, calcium ions, magnesium ions, dissolved organics, free oil and grease.

3. The process of claim 1 wherein:
the contaminant species is selected from one or more of the group consisting of boron, dissolved organics and free oil.

4. The process of claim 1 wherein:
the polyvalent osmotic agents are selected from one or more of the group consisting of Na₂SO₄, MgCl₂, AlCl₃, and MgSO₄.

5. The process of claim 1 wherein:
the polyvalent osmotic agent is MgCl₂.

6. The process of claim 1 wherein:
the molarity of the polyvalent osmotic agents in the draw solution is at least 0.5M.

7. The process of claim 1 wherein:
the molarity of the polyvalent osmotic agents in the draw solution is at least 2.5M.

8. A hybrid forward osmosis and nanofiltration system for treating produced water containing contaminant species, the system comprising:
a forward osmosis cell including a forward osmosis (FO) feed chamber and a forward osmosis (FO) draw chamber separated by a forward osmosis (FO) membrane, the FO draw chamber including a draw solution containing a solution including polyvalent osmotic agents; and
a nanofiltration cell including a nanofiltration (NF) draw chamber and a nanofiltration (NF) permeate chamber separated by a nanofiltration membrane, the NF draw chamber in fluid communication to receive an outlet draw solution from the FO draw chamber and in fluid communication to deliver an inlet draw solution to the FO draw chamber;
wherein produced water containing contaminant species may be introduced into the FO feed chamber with the produced water being separated into a contaminant species enriched retentate stream in the FO feed chamber and a first contaminant species depleted permeate stream in the FO draw chamber to mix with the draw solution to form the outlet draw solution; and
wherein the outlet draw solution can be separated by the nanofiltration membrane into a contaminant species enriched inlet draw solution in the NF feed chamber which can be recycled to the FO draw chamber and a second contaminant species depleted permeate stream in the NF permeate chamber.

9. The system of claim 8 wherein:
the contaminant species is selected from one or more of the group consisting of silica, boron, calcium ions, magnesium ions, dissolved organics, free oil and grease.

10. The system of claim 8 wherein:
the contaminant species is selected from one or more of the group consisting of boron, dissolved organics and free oil.

11. The system of claim 8 wherein:
the polyvalent osmotic agents are selected from one or more of the group consisting of Na₂SO₄, MgCl₂, AlCl₃, and MgSO₄.

12. The system of claim 8 wherein:
the polyvalent osmotic agent is MgCl₂.

13. The system of claim 8 wherein:
the molarity of the polyvalent osmotic agents in the draw solution is at least 0.5M.

14. The system of claim 8 wherein:
the molarity of the polyvalent osmotic agents in the draw solution is at least 2.5M.
